(19) United States
(12) Patent Application Publication
(10) Pub. No.: US 2026/0189754 A1
(43) Pub. Date: Jul. 2, 2026

(54) VIDEO SECURITY FOR MULTIPLE DISPLAYS

(71) Applicants: ADVANCED MICRO DEVICES, INC., Santa Clara, CA (US); ATI TECHNOLOGIES ULC, Markham (CA)

(72) Inventors: Kaushal Amolak Sanghai, Boxborough, MA (US); Dennis K.W. Au, Markham (CA); Nicholas James Chorney, Mississauga (CA); Kathirkamanathan Nadarajah, Markham (CA)

(21) Appl. No.: 19/005,555

(22) Filed: Dec. 30, 2024

(51) Int. Cl. H04N 21/454

(52) U.S. Cl. CPC H04N 21/454

(57) ABSTRACT

A processor supports selective provision and blocking of content (e.g., video or other visual content) to different display devices based on the encryption standards of those display devices. The processor identifies the encryption standard required for the content (that is, the process by which the content has been or is to be encrypted) and whether the encryption standard for each display device meets the encryption standard of the content. The processor then provides the content to the display devices whose encryption standards meet the standard of the content, and blocks provision of the content to any display device that does not meet the encryption standard of the content.

### BACKGROUND

Processing systems are often used to present digital content, such as entertainment content, to a user. For example, some processing systems are employed to receive one or more streams of digital content from a wide-area network, such as the Internet, and present that content to the user. Examples of such digital content include game content, video entertainment content (e.g., television shows or movies), and the like. In many cases, the digital content is owned by a content provider, rather than the user, and the content provider implements a digital rights management (DRM) scheme to protect the digital content from unauthorized copying, storage, or other access. In some cases, as part of the DRM scheme, the content provider provides the content in a copy-protected encrypted format, such as High-bandwidth Digital Content Protection (HDCP) format. Furthermore, different content providers, or different content streams from the same provider, are sometimes implemented with different encryption formats. These different formats present a challenge to a processing system to process and present the content to a user.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that selectively provides and blocks content from provision to different display devices based on the encryption capabilities of the display devices in accordance with some implementations.

FIG. 2 is a block diagram illustrating an example of the processing system of FIG. 1 selectively providing and blocking content from provision to different display devices in accordance with some implementations.

FIG. 3 is a block diagram illustrating another example of the processing system of FIG. 1 selectively providing content provision to different display devices in accordance with some implementations.

FIG. 4 is a block diagram illustrating an example of the processing system of FIG. 1 selectively providing and blocking blended/combined content from provision to different display devices in accordance with some implementations.

FIG. 5 is a block diagram of a display engine of the processing system of FIG. 1 that supports selective provision and blocking of content in accordance with some implementations.

FIG. 6 is a flow diagram of a method of selectively providing and blocking content from provision to different display devices based on the encryption requirements of the display devices in accordance with some implementations.

### DETAILED DESCRIPTION

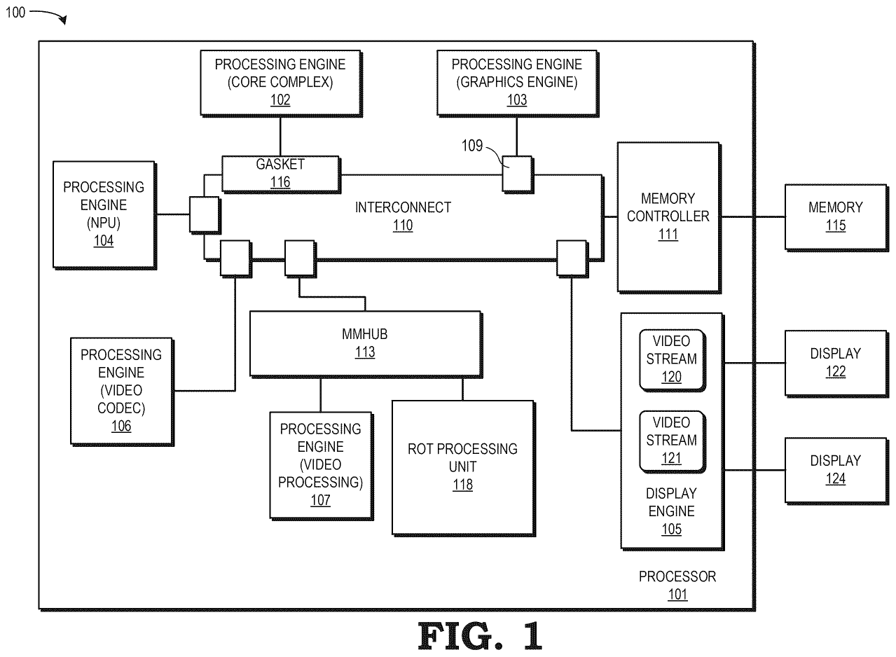

FIGS. 1-6 illustrate techniques for supporting, at a processor, selective provision and blocking of content (e.g., video or other visual content) to different display devices based on the encryption standards of those display devices. The processor identifies the encryption standard required for the content (that is, the process by which the content has been or is to be encrypted) and whether the encryption standard for each display device meets the encryption standard of the content. The processor then provides the content to the display devices whose encryption standards meet the standard of the content, and blocks provision of the content to any display device that does not meet the encryption standard of the content. The processor thereby protects the content from unauthorized access while supporting a good user experience by allowing the content to be displayed at compliant display devices.

To illustrate via an example, in some implementations a processor is connected to two display devices, designated Display Device A and Display Device B. Each of the Display Devices is configured to comply with different HDCP encryption standards. In particular, Display Device A complies with the HDCP 1.x standard, while Display Device B complies with the HDCP 2.0 standard. A processing engine of the processor generates content that is required to be encrypted according to the HDCP 2.0 standard. Conventionally, a processor determines the encryption standard that allows content to be displayed at any of the connected display devices, and only provides content that complies with that lowest encryption standard. Thus, a conventional processor would determine that the encryption standard between Display Device A and Display Device B is HDCP 1.x, because HDCP 1.x content is able to be displayed at either of Display Device A or Display Device B, whereas HDCP 2.x content is only able to be displayed at Display Device A. Accordingly, the conventional processor therefore does not provide the HDCP 2.0 content to either Display Device A or Display Device B. That is, the content would not be displayed at any display device, resulting in a poor user experience. Using the techniques herein, the processor provides the HDCP 2.x content to Display Device A (which complies with HDCP 2.x) and blocks the content from provision to Display Device B (which does not comply with HDCP 2.x). The processor thus protects the content from unauthorized access while still allowing the content to be displayed at compliant display devices, thus improving the user experience.

In some implementations, the processor generates different content streams (e.g., video streams) with each content stream being encrypted, or is required to be encrypted, according to different standards, and wherein the processor blends, combines, or blends and combines the content streams into a single window or set of frames for concurrent display. As used herein, the term blended/combined content refers to blended streams, combined streams, or blended and combined streams. For such blended/combined content, the processor identifies the highest required encryption standard across all the content streams (e.g., the required encryption standard, among all the streams, having the highest security level). The highest required encryption standard is the highest standard according to which the content streams have already been encrypted or are required to be encrypted prior to provision to the corresponding display device. The processor selectively provides and blocks provision of the blended/combined content to each different display device based on whether each of the display devices satisfies (that is, complies with) the identified highest required encryption standard. The processor thus protects blended/combined content from unauthorized access.

FIG. 1 illustrates a block diagram of a processing system 100 that is generally configured to present digital data to a user in accordance with some implementations. Examples of the digital data include image data, audio data, and the like or any combination thereof. Thus, in different implementations, the digital data includes game data, video data (e.g., movies and television), audio data (e.g., music), and the like, or any combination thereof. Accordingly, in different implementations, the processing system 100 is implemented, or partially implemented, in an electronic device configured to present digital data to a user, such as desktop computer, laptop computer, game console, smartphone, tablet, television, automobile, and the like.

To support presentation of digital content, the processing system 100 includes a processor 101 and a memory 115. It will be appreciated that, at least in some implementations, the processing system 100 includes additional circuitry, not illustrated at FIG. 1, that supports presentation of digital data, such as one or more display devices, one or more input/output devices and associated controllers, one or more network interfaces, one or more power sources and associated circuitry, and the like, or any combination thereof. Turning to the circuitry illustrated at FIG. 1, the memory 115 is a set of one or more memory devices generally configured to store data on behalf of the processor 101. Thus, in the course of performing one or more aspects of the operations described herein, the processor 101 generates memory operations that store data at the memory 115 (e.g., write operations), retrieve data from the memory 115 (e.g., read operations), or a combination thereof. Accordingly, in different implementations the memory 115 includes random access memory (RAM), non-volatile memory (e.g., flash memory), storage devices such as hard disc drives and solid-state disc drives, and the like, or any combination thereof. It will be appreciated that in some implementations the processing system 100 includes additional memory not shown at FIG. 1, such as one or more caches, buffers, registers, and the like, and associated control circuitry.

The processing system 100 further includes a processor 101 generally configured to carry out processing operations, including one or more of general-purpose processing operations (e.g., execution of an operating system and application software), graphics processing operations, audio processing operations, display processing operations, machine learning and neural network operations, data security operations, and the like, or any combination thereof. To support execution of these operations, the processor 101 includes a plurality of processing engines, designated processing engines 102-107. Each of the processing engines 102-107 is generally configured to carry out processing operations of a designated type, or set of types, independently of the other processing engines. This allows the processor 101 to carry out multiple tasks at the different processing engines in parallel, thus improving processing efficiency.

To illustrate, in the example of FIG. 1 the processor 101 is assumed to be a multimedia processor generally configured to execute multimedia operations, including processing and presentation of audio data, image data, video data, and the like. Accordingly, each of the processing engines 102-107 is generally configured to carry out operations associated with one or more multimedia tasks. Thus, for the example of processing system 100, the processing engine 102 is a core complex including one or more processor cores that collectively form one or more central processing units (CPUs). The one or more CPUs are configured to execute (e.g., via one or more instruction pipelines) general-purpose processing tasks, such as execution of an operating system, user interface programs, productivity applications, and the like. The processing engine 103 is a graphics engine including one or more graphics processing units (GPUs) generally configured to execute graphics operations, such as draw operations, raytracing operations, image frame generation operations, and the like, or any combination thereof.

The processing engine 104 is an inference processing unit (IPU), also referred to as a neural processing unit (NPU), generally configured to execute machine learning operations, such as execution of operations associated with one or more machine learning models (MLMs). Thus, in some implementations the NPU is configured to execute the operations associated with different layers of the MLM, including application of input data to an initial layer of the MLM, performing the calculations (e.g., matrix multiplications) for each layer of the MLM and based on the weights assigned to each layer, and generation of an output of the MLM at a final layer.

The processing engine 105 is a processing engine generally configured to execute display operations, including processing of pixel data and providing the pixel data to display devices 122 and 124 to display. Examples of such display operations include one or more of color space conversion, linearization of pixel data, tone mapping, gamut mapping, plane blending, pixel formatting, display writeback, and the like, or any combination thereof. The processing engine 105 is also referred to herein as display engine 105. The display devices 122 and 124 are devices, such as display panels, configured to receive the pixel data (e.g., images) from the display engine 105 and to display the provided pixel data, as described further herein.

The processing engine 106 is an audio/video codec processing engine and is generally configured to perform operations associated with one or more specified video codecs. Thus, for example, the processing engine 106 is configured to execute compression operations for video or audio data, decompression operations for video or audio data, and the like, or any combination thereof. The processing engine 107 is a video processing engine configured to execute video processing operations. Thus, for example, in some implementations the processing engine 107 executes decoding operations, de-interlacing operations, gamma correction operations, scaling, filtering, and sharpening operations, encoding operations, quantization operations, discrete cosine transformation (DCT) and inverse DCT operations, motion compensation operations, blending operations, dithering operations, and the like, or any combination thereof.

It will be appreciated that the above-described processing engines are examples only, and that the techniques described herein apply to processors and processing systems having additional, fewer, or different processing engines than those illustrated in the example of FIG. 1. Further, although the different processing engines 102-107, and other circuits, are illustrated as being incorporated in a single processor 101, in other implementations one or more of the processing engines is incorporated in a different processor, different integrated circuit, different chiplet, and the like, or any combination thereof.

The processing engines 102-107 are configured to communicate with each other via an interconnect 110. In different implementations, the interconnect 110 is any fabric, or combination of fabrics, configured to route messages between different fabric ports. Thus, in different implementations, the communication fabric is a Peripheral Component Interconnect Express (PCIe) fabric, an Infinity Fabric (IF), or other communication fabric. In operation, the processing engines 102-107 communicate with each other via messages referred to herein as transactions. Each transaction includes a request (e.g., a command) for a processing engine to perform one or more operations, results of operations executed by a processing engine, and the like, or any combination thereof. For example, in some implementations, the processing engine 102 (the core complex) executes an application program. In the course of execution, the application generates one or more draw commands, and the processing engine 102 sends the draw commands, via one or more transactions, to the processing engine 103 (the graphics engine). The processing engine 103 executes the draw commands and provides the results of the draw operations, via one or more transactions, to, for example, the display engine 105 (the display processor). In response, the display engine 105 displays one or more frames for display at one or more of the display devices 122 and 124.

The processor 101 further includes a memory controller 111 to support interaction with the memory 115 by the processing engines 102-107. In particular, the memory controller 111 includes circuits to receive memory access requests from the processing engines 102-107 via the interconnect 110, and to translate those memory access requests into control signaling. The memory controller 111 provides the control signaling to the memory 115 in order to carry out the memory access requests, and provides any responsive information (e.g., data read from the memory 115) to the processing engine that issued the memory access request.

In addition, the processor 101 includes a multimedia hub (MMHUB) 113 generally configured to manage multimedia and other operations for connected processing engines, such as the processing engine 107. Thus, for example, in some implementations the MMHUB 113 aggregates transactions received from, and targeted to, the connected processing engines and other processors, and manages provision of those transactions to their targeted destinations. Accordingly, the MMHUB 113 includes circuits to perform aggregation operations such as transaction buffering, transaction flow management (e.g., backpressure, transaction priority management, and other management operations), and the like, or any combination thereof.

In some implementations, the processor 101 is generally configured to store and process sensitive data—that is, data that is to be protected from unauthorized access. To support data security, the processor 101 includes a root-of-trust (RoT) processing unit 118. The RoT processing unit 118 is a processing unit that is isolated from access by the processing engines 102-107 and is generally configured to perform security operations for the processor 101. Examples of such security operations, in different implementations, include: reception of cryptographic keys from a server (not shown) via a network, decryption of encrypted keys, provision of cryptographic keys to one or more of the processing engines 102-107 and the memory controller 111, management of a secure boot process for the processor 101, setting of security policies at the processor 101, handling of security interrupts at the processor 101, authentication and loading of firmware at the processing engines 102-107, managing software and hardware trust levels at the processor 101, and the like, or any combination thereof.

In some implementations, the RoT processing unit 118 is configured to provision and manage security spaces, referred to as keyspaces, for the processor 101. Each keyspace corresponds to one or more security aspects of the processor 101, and the ROT processing unit 118 is configured to assign entities to the keyspaces, wherein the entities include one or more of the processing engines 102-107, one or more executing programs (e.g., one or more virtual machines), one or more DRM channels, and the like, or any combination thereof. The security aspects of a keyspace, in different implementations, include one or more of a cryptographic key (e.g., a local key), permission levels (e.g., permission to access a DRM channel), read privileges (e.g., permission to read data), write privileges (e.g., permission to write data), and the like, or any combination thereof. Furthermore, each of the keyspaces is configurable by the RoT processing unit 118, allowing the processing unit 118 to configure the different keyspaces differently for different processing systems and processing system applications. Furthermore, in some implementations, at least some of the keyspaces are managed, or managed in part, by an operating system executing at the processing engine 102, by a hypervisor (not shown), or a combination thereof.

To illustrate, in some implementations the processor 101 employs keyspaces to govern access to different encrypted memory spaces (not shown) at the memory 115. The RoT processing unit 118 provisions (e.g., from a trusted server) a different cryptographic key to each of two keyspaces and assigns each keyspace to a different one of the encrypted memory spaces. The RoT processing unit 118, an operating system, or a hypervisor, assigns each keyspace to a different program (e.g., a different virtual machine) executing at the processing engine 102. The memory controller 111 includes an encryption/decryption circuit (not shown) that encrypts and decrypts data based on a cryptographic key (e.g. an Advanced Encryption Standard (AES)-128 or AES-256 key). The RoT processing unit 118 provides the cryptographic key for each keyspace to the encryption/decryption circuit at the memory controller 111. When a program executing at the processing engine 102 generates a memory transaction (e.g., a read or write operation) targeting an encrypted memory space, the program provides with the memory transaction (e.g., via a memory address) a keyspace identifier. The encryption/decryption circuit uses the keyspace identifier (referred to as a key ID) to identify a provided cryptographic key and uses the key to encrypt (for a write operation) or decrypt (for a read operation) the corresponding data. The processor 101 thus allows different programs executing at the processing engine 102 to employ protected (trusted) memory spaces to store sensitive data, and thereby protect the data from unauthorized access.

In some implementations, the processor 101 employs keyspaces and a set of hardware gaskets (e.g., gaskets 109 and 116) to establish and enforce a set of hardware-isolated DRM channels. Each of the gaskets governs access to an ingress port of the interconnect 110 for a corresponding one of the processing engines 102-107. Thus, for example, the gasket 116 governs access to the interconnect 110 by the processing engine 102, while the gasket 109 governs access to the interconnect 110 by the processing engine 103. It will be appreciated that in the illustrated example of FIG. 1, the gaskets are located at the interconnect 110 itself (e.g., as part of the circuitry for each ingress port). However, in other implementations the gaskets are located, for example, at each of the processing engines 102-107, at one or more hubs of the processor 101 (e.g. at the MMHUB 113), and the like.

In some implementations, the processing engines 102-107 generate content, such as video streams 120 and 121, and designates that the content is to be encoded according to a specified encryption standard (ES) for display. This is referred to herein as the required encryption standard for the stream. As used herein for purposes of description, the required encryption standard for a stream refers to either 1) the encryption standard according to which the stream has been encrypted, for streams that are encrypted prior to being provided to the display engine 105; and 2) the encryption standard according to which the stream is to be encrypted by the display engine 105 prior to being provided to the display device (for streams that are to be encrypted by the display engine 105). For example, in some implementations the different DRM channels specify a required encryption standard for particular content to be generated, and when a processing engine generates content for that DRM, the processing engine designates (e.g., via metadata, or within the content itself) that the content is to be encrypted according to the specified required encryption standard.

As used herein, an encryption standard refers to a set of requirements for encrypting content, and the term “encrypting according to the standard” refers to encrypting the content to meet the set of requirements. Examples of encryption standards include HDCP standards (such as HDCP 1.x, HDCP 2.x Type 0, and HDCP 2.x Type 1). For purposes of the examples described herein, an encryption standard is referred to as a “higher” encryption standard when that encryption standard has higher encryption requirements than another encryption standard, and encryption standards with higher version numbers are assumed to be higher encryption standards relative to encryption standards with lower version numbers. Thus, for example, as used herein ES 2.0 (e.g., HDCP 2.x) is a higher encryption standard than ES 1.0 (e.g., HDCP 1.x). As another example, in some implementations ES 0.0 corresponds to a “no encryption” standard (that is, the content is not encrypted and is not designated for encryption), ES 1.0 corresponds to HDCP 1.x content, ES 2.0 corresponds to HDCP 2.x type 0 content, and ES 3.0 corresponds to HDCP 2.x type 1 content.

In some cases, a video stream is designated for display via an embedded display port (eDP), such as a laptop monitor. In some implementations, a video stream designated for display via an eDP is displayed at the internal display device, without encrypting the stream, as the stream is assumed to be protected internally at the processing system 100. However, the required encryption standard for the stream is maintained at the processing system 100, so that if the content is redesignated for display at an external display device (e.g., because a user drags a window with the content to the external display device), the video stream is displayed according to the required encryption standard, as described further herein.

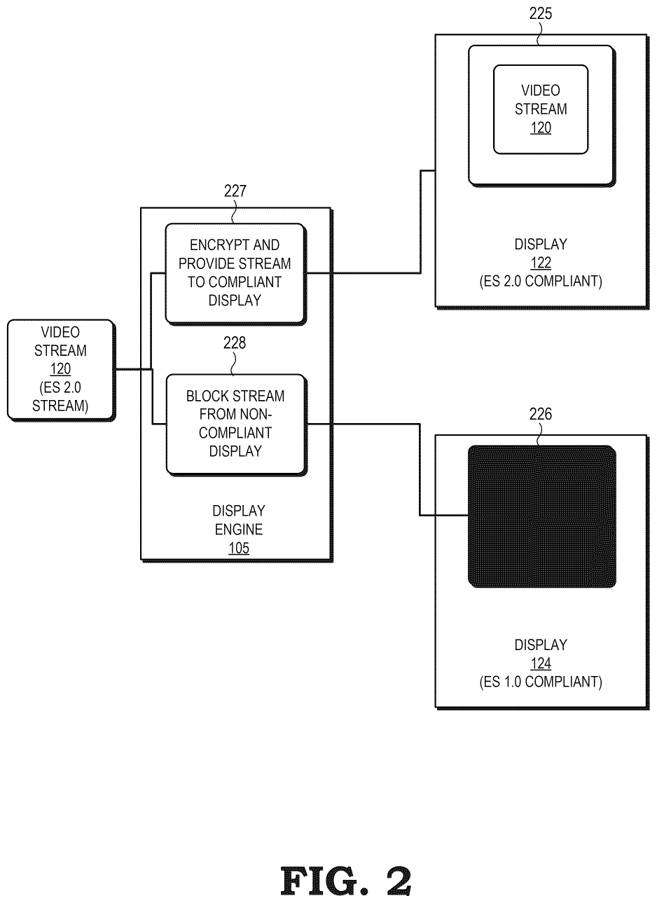

In some cases, the processing engines 102-107 produce different content for display having different required encryption standards. For example, in some implementations the video stream 121 is designated to be encrypted according to the ES 1.0 standard, and the video stream 120 is designated to be encrypted according to the ES 2.0 standard. Furthermore, in some implementations, the display devices 122 and 124 are each configured to comply with different encryption standards. Thus, for example, in some implementations the display device 122 is compliant with ES 2.0 standard, and the display 124 is compliant with the ES 1.0 standard. The display engine 105 is configured, for each of the video streams 120 and 121, to 1) identify the required encryption standard for the stream; 2) encrypt the video stream according to the identified required encryption standard; and 3) to provide the stream to its targeted display device if the display device complies with the identified required encryption standard for the stream; and 4) to block the stream from provision (e.g., not provide the stream) to its targeted display device if the display device does not comply with the required encryption standard for the stream. An example is illustrated at FIG. 2 in accordance with some implementations.

In the example of FIG. 2, the display engine 105 receives the video stream 120, designated to be encrypted according to the ES 2.0 standard (that is, the required encryption standard for the video stream is ES 2.0). Furthermore, in the example of FIG. 2, the display device 122 complies with the ES 2.0 standard, while the display 124 complies only with the ES 1.0 standard. Thus, the display 124 is not configured to properly protect the video stream 120.

The display engine 105 receives the video stream 120 and determines that the required encryption standard for the video stream 120 is the ES 2.0 standard. For example, in some implementations the video stream 120 includes an identifier (e.g., in a header of the stream, in metadata provided with or separately from the stream, or in a hardware signal or stream identifier provided by the RoT processing unit 118) indicating the required encryption standard. In still other implementations, the video stream 120 is generated by a DRM pipe, and the display engine 105 receives the key ID corresponding to the DRM pipe to which the stream is assigned. The display engine 105 uses the key ID to identify the required encryption standard for the video stream 120, such as by using the key ID to index a look-up table that stores the required encryption standard assigned to each DRM pipe.

The display engine 105 further determines the encryption standards for each of the display devices 122 and 124. These encryption standards are referred to as the security characteristics for the display devices 122 and 124. That is, the security characteristics of a display device, such as the display device 122, indicate the encryption standard that the display device complies with, and thus that the display device implements the encryption, decryption, or other security features indicated by the encryption standard. For example, in some implementations, during a boot process for the processing system 100, or when the display devices 122 and 124 are connected to the processing system 100, the display engine 105 performs a handshake process with each of the display devices 122 and 124. During the handshake process, the display engine 105 receives metadata from each of the display devices 122 and 124 indicating the security characteristics, including the encryption standard, for each device. The display engine 105 thus determines that the display 122 is compliant with the ES 2.0 standard, and therefore that the encryption standard for the display device 122 matches the required encryption standard for the video stream 120. As used herein, the encryption standard for a display device matches a required encryption standard if the encryption standard for the display device meets or exceeds the required encryption standard. Furthermore, if the encryption standard for a display device does not meet or exceed the required encryption standard for a stream, this is referred to herein as a mismatch between the encryption standard for the display device and the required encryption standard. Thus, for example, a display device with an encryption standard of ES 2.0 matches a required encryption standard of ES 2.0, ES 1.0, and ES 0.0. In response to the encryption standard for the display device 122 matching the required encryption standard for the video stream 120, the display engine 105, as indicated by block 227, encrypts the video stream 120 according to the ES 2.0 standard and provides the encrypted video stream 120 to the display device 122. The video stream 120 is thus displayed at the display device 122 in a window 225. The display engine 105 also determines that the display 124 does not comply with the ES 2.0 standard (that is, identifies a mismatch between the encryption standard for the display device 124 and the required encryption standard for the video stream 120). Accordingly, the display engine 105 prevents the video stream 120 from being provided to the display device 124, as shown at block 228. For example, in some implementations the display engine 105 replaces the video stream 120 in a video buffer assigned to the display device 124 with a predefined image, such as an error message or a set of black pixels that are displayed at the display device 124 via a window 226. In other embodiments, the display engine 105 prevents provision of the video stream 120 to the display device 124 by discarding one or more frames of the video stream 120, or by holding the video stream 120 in a buffer and omitting control signaling or commands that send the contents of the buffer to the display device 124.

It will be appreciated that in the example of FIG. 2, the windows 225 and 226 are displayed at the display devices 122 and 124 concurrently. However, in other implementations, the selective provision and blocking of the video stream 120 by the display engine 105 occurs serially, over time. For example, in some implementations the video stream 120 is initially targeted for display at the display device 122, and not the display device 124. Accordingly, the display engine 105 provides the video stream 120 to the display device 122, as shown at block 227. Subsequently, a user requests a transfer of the video stream 120 to the display device 124 (e.g., by dragging the window 225 to the display device 124). In response, as shown at block 228, the display engine 105 blocks provision of the video stream 120 to the display device 124.

It will be appreciated that the required encryption standards, and the encryption standards for the display devices 122 and 124 illustrated at FIG. 2 are examples only, and in other implementations the required encryption standards, the encryption standards for the display devices, or any combination thereof, are different. For example, in some implementations the display device 124 has an encryption standard of ES 0—that is, the display device 124 does not comply with any encryption standard (e.g., is not compliant with HDCP 1.x, HDCP 2.x, or any other HDCP standard). Accordingly, the display engine 105 does not provide, to the display device 124, any video stream that requires encryption—that is any video stream that has a required encryption standard of ES 1.0 or higher (e.g., a video stream that has a required encryption standard of HDCP 1.x or HDCP 2.x).

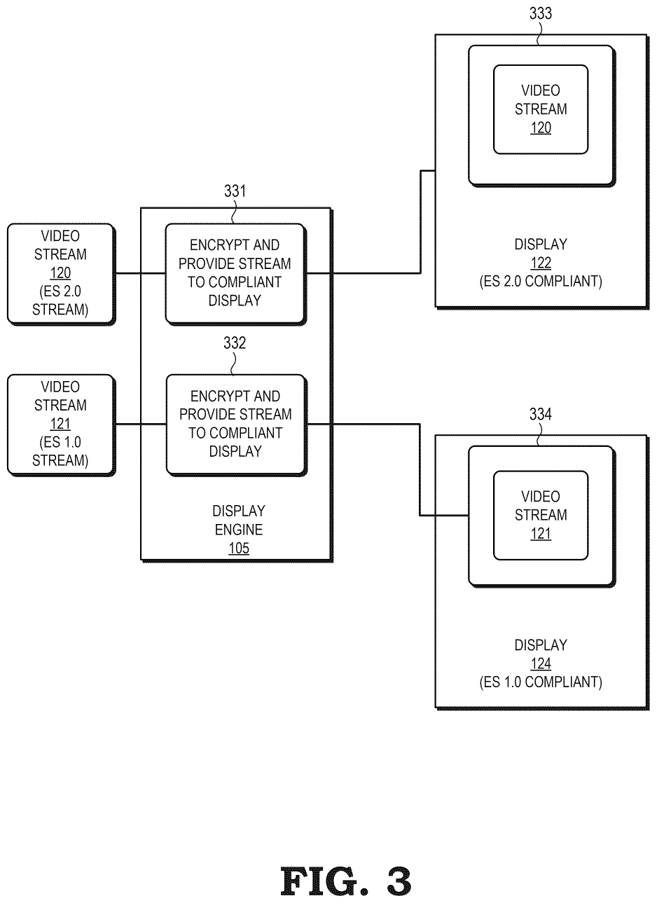

FIG. 3 illustrates another example of the display engine 105 providing video streams to the display devices 122 and 124 in accordance with some implementations. In the illustrated example, the display engine 105 receives the video stream 120. The required encryption standard for the video stream 120 is the ES 2.0 standard and the video stream 120 is designated for display at the ES 2.0 compliant display device 122. In addition, the display engine 105 receives the video stream 121. The required encryption standard for the video stream 121 is the ES 1.0 standard and the video stream 121 is designated for display at the ES 1.0 compliant display device 124.

It is assumed for the purposes of the example of FIG. 3 that the video streams 120 and 121 are to be displayed concurrently at the display device 122 and 124, respectively. In a conventional processing system, the system determines the lowest encryption standard among the display devices 122 and 124, and further determines that one of the video streams 120 and 121 has a required encryption standard that is higher than the determined lowest encryption standard for the display devices 122 and 124. In particular, the conventional processing system determines that the video stream 120 has a required encryption standard of ES 2.0 and identifies that the display device 124 does not comply with ES 2.0. Accordingly, the conventional system either 1) displays only video stream 121; or 2) downgrades the designated encryption standard for the video stream 120 to a lower encryption standard, such as ES 1.0, thereby reducing the security level of the stream. That is, the conventional processing system ensures that any received video stream is able to be displayed at any connected display device.

In contrast to the conventional processing system, the processing system 100 displays video streams according to their individual required encryption standards and corresponding encryption standard compatibility of the designated display devices. Thus, in the example of FIG. 3, the display engine 105 determines that the video stream 120 is to be encrypted according to the ES 2.0 standard, and that the video stream 120 is to be displayed at the display device 122. The display engine 105 further determines that the display device 122 complies with the ES 2.0 standard. Accordingly, as illustrated at block 331, the display engine 105 encrypts the video stream 120 according to the ES 2.0 standard and provides the encrypted video stream 120 to the display device 122. In response, the display device 122 displays the video stream 120 at a window 333.

Similarly, the display engine 105 determines that the video stream 121 is to be encrypted according to the ES 1.0 standard, and that the video stream 121 is to be displayed at the display device 124. The display engine 105 further determines that the display device 124 complies with the ES 1.0 (or higher) standard. Accordingly, as illustrated at block 332, the display engine 105 encrypts the video stream 121 according to the ES 1.0 standard and provides the encrypted video stream 121 to the display device 124. In response, the display device 124 displays the video stream 121 at a window 334. Thus, in the example of FIG. 3, the display of the different video streams 120 and 121 is dependent only on the designated encryption standard of the individual stream and the encryption compliance level of the display device that is to display the stream.

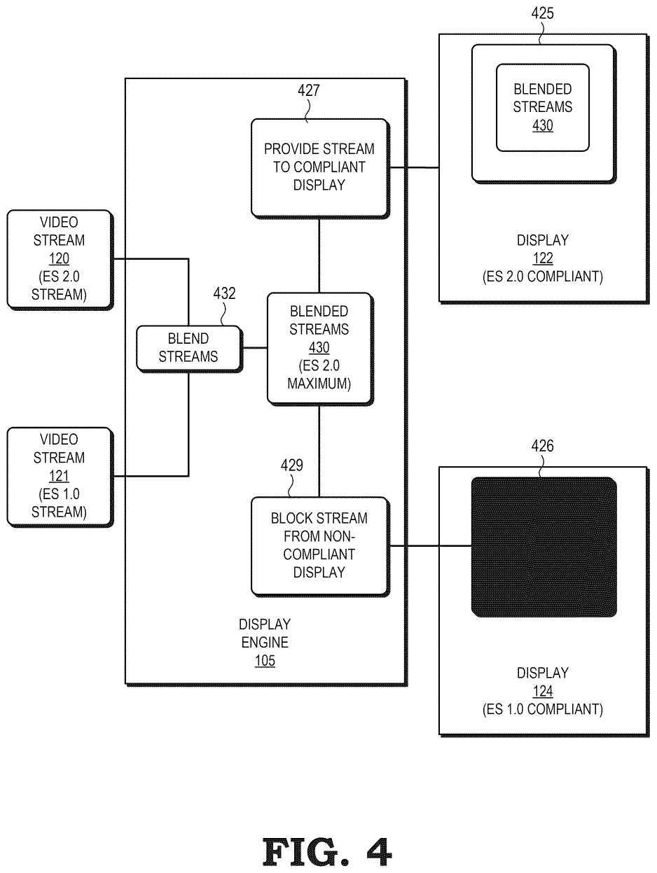

In some cases, the display engine 105 blends or combines (or both) different video streams into a single window or frame for display at a display device, wherein the different video streams have different required encryption standards. An example is illustrated at FIG. 4 in accordance with some implementations. In the depicted example, the display engine receives, for display in the same window or frame, the video stream 120 and the video stream 121. The video stream 120 is an ES 2.0 stream (that is, has been encrypted according to the ES 2.0 standard) and the video stream 121 is an ES 1.0 stream. In addition, in the example of FIG. 4 the display 122 is ES 2.0 compliant, while the display 124 is ES 1.0 compliant.

The display engine 105 prepares the video streams 120 and 121 for display by blending the streams according to a specified image blending process. This blending is illustrated at block 432, and results in a blended stream 430. To determine which of the display devices 122 and 124 is eligible to display the blended stream 430, the display engine 105 determines the maximum required encryption standard among the blended streams. That is, the display engine 105 determines the highest level of encryption, among the different required encryption standards, among the blended streams, and only provides the blended stream to the displays that comply with the highest level of encryption (thus protecting all the streams of the blended stream). In the example of FIG. 4, the maximum required encryption standard of the blended stream is ES 2.0. Accordingly, at block 427, the display engine 105 provides the blended stream 430 to the display device 122 for display at a window 425. However, because the display device 124 does not comply with ES 2.0, at block 429 the display engine 105 blocks provision of the blended stream 430 to the display device 124, and instead provides a blank frame for display at a window 426. Thus, as illustrated by the example of FIG. 4, the display engine ensures that blended streams are only provided to display devices that support the required encryption standard (that is, meet or exceed the required encryption standard), of all of the streams that are blended.

It will be appreciated that, in the example of FIG. 4, it is assumed that the video streams 120 and 121 are blended into a common plane, such as by blending overlapping portions of the video streams 120 and 121 via alpha blending. In some implementations, the video streams 120 and 121 are not overlapping, and are not blended, but instead are combined into a single window or frame. In these implementations, the display engine 105 determines the highest required encryption standard, among the different required encryption standards, among the combined streams, and only provides the combined stream to the displays that comply with the highest required encryption standard (thus protecting all the streams of the combined stream). In still other implementations, the display engine 105 both blends and combines video streams. For example, the display engine blends one or more sets of video streams, and then combines the resulting one or more blended sets of video streams into a blended and combined video stream. In these implementations, the display engine 105 determines the highest required encryption standard, among the different required encryption standards, among the blended and combined streams, and only provides the blended and combined stream to the displays that comply with the highest required encryption standard.

It will be appreciated that in some implementations, the processing system 100 includes one or more integrated or embedded display devices, such as display devices connected to the display engine 105 via an Embedded DisplayPort (eDP). In at least some of these implementations, the display engine 105 does not encrypt (that is, omits encryption of) the video stream prior to providing the video stream to the integrated or embedded display, even if the required encryption level for the video stream requires encryption, as the integrated or embedded display is assumed to be protected. If the video stream is redesignated for display at an external display, the display engine 105 employs the required encryption level for the stream to determine whether to provide the stream to the external display, as described above. That is, the required encryption level is employed by the display engine 105 to determine whether to display a video stream at an external display device, but is not used when providing the video stream to an embedded or internal display device.

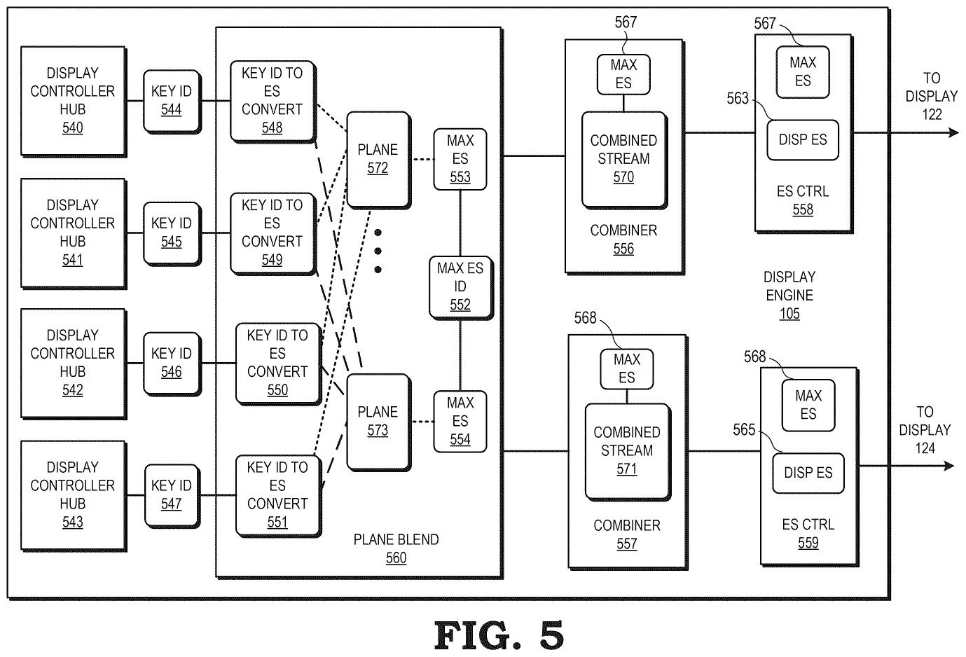

FIG. 5 illustrates a block diagram of the display engine 105 in accordance with some implementations. In the depicted example, the display engine 105 includes a plurality of display controller hubs (e.g., display controller hubs 540-543). Each display controller hub is configured to act as a gateway between one or more of the processing engines 102-104, 106, and 107, and the display engine 105. Accordingly, each display controller hub performs operations such as memory arbitration, rotation, cursor manipulation, and the like. In addition, each display controller hub is configured to receive content streams for the corresponding processing engine. Based on the received content stream, the display controller hub determines a key ID for the DRM channel to which the content stream is assigned. In some implementations, the key IDs for each DRM channel are provided to the display engine 105 by the RoT processor 118. In other implementations, the key ID is provided with the corresponding content stream. Thus, in the illustrated example, each of the display controller hubs 540-543 identifies a key ID, illustrated as key IDs 544-547 in FIG. 5, respectively, for a corresponding received content stream (not shown).

The display engine 105 also includes plane blend circuitry 560 configured to perform blending operations of received content streams, such as blending based on global or per-pixel alpha values. In some implementations, the plane blend circuitry 560 is configured to perform pre-blend processing such as color space conversion, linearization of pixel data, tone mapping, and gamut mapping. Based on these operations, the plane blend circuitry 560 generates one or more planes, such as planes 572 and 573. In some implementations, the plane blend circuitry 560 is configured such that the circuitry blends the received streams according to commands received from one or more of the processing engines 102-104, 106, and 107. Thus, depending on the received commands, the plane blend circuitry 560 blends the received streams in any combination (wherein the particular combination for a given plane is indicated by the received commands).

In addition, the plane blend circuitry is configured to convert the key IDs 544-547 to correspond encryption standard (ES) values, as illustrated by blocks 548-551. Each of the blocks 548-551 correspond to circuitry that employs a look-up table to determine, for a received key ID, the corresponding ES for the DRM channel corresponding to the key ID. It will be appreciated that employing a key ID to indicate the ES is an example only, and in other implementations other values are employed to indicate the ES. In some implementations, the look up table employed by the blocks 548-551 is generated by the RoT processing unit 118 during a boot process for the processor 101.

The plane blend circuitry 560 also includes maximum ES identifier circuitry 552, to determine, for each plane, the maximum required ES among the different streams that have been blended to form the plane. Thus, for the example of FIG. 5, the maximum ES identifier circuitry 552 generates a maximum ES value 553 for the plane 572, representing the highest required ES value among all the streams that were blended to form the plane 572. Similarly, for the plane 573, the maximum ES identifier circuitry 552 generates a maximum ES value 554, representing the highest required ES value among all the streams that were blended to form the plane 573.

The display engine 105 further includes combiner circuitry 556 and 557. Each of the combiner circuitry is associated with a connected display device and based on received commands combines one or more streams received from the plane blend circuitry 560 to form one or more combined streams for display at the connected display device. Thus, in the example of FIG. 5, the combiner circuitry 556 combines one or more video streams received from the plane blend circuitry 560 to generate a combined stream 570 for display at the display device 122. Similarly, the combiner circuitry 557 combines one or more received video streams to generate a combined stream 571. In some implementations, one or more of the streams combined to form the combined stream 570, the combined stream 571, or both, includes one or more blended planes (e.g., planes 572, 573), with each blended plane including different video streams that have been blended as described above.

Each of the combiner circuitry 556 and 557 is configured to identify a maximum ES value, designated maximum ES 567 and 568, respectively, for the corresponding combined stream. Thus, the combiner circuitry 556 is configured to identify the highest required ES value among all the streams combined to form the combined stream 570, and to employ the identified highest required ES value as the maximum ES value 567. Similarly, the combiner circuitry 557 is configured to identify the maximum ES value 568 by identifying the highest required ES value among all the streams combined to form the combined stream 571. In some implementations, the combiner 556 determines the highest required ES value by determining the maximum required ES value for each plane being combined to generate the combined stream 570 and identifying the highest value among the maximum ES value. Thus, for example, if the combined stream 570 is formed from the planes 572 and 573, the combiner circuitry 556 determines the maximum required ES value 567 by identifying the higher of the maximum required ES value 553 and the maximum required ES value 554.

The display engine 105 further includes ES control circuitry 558 and 559, each configured to compare the maximum required ES value for the corresponding combined streams to a display ES value for the corresponding display, and based on the comparison to either 1) encode the combined streams according to the encryption standard indicated by the maximum required ES value and provide the encoded combined streams to the display device or 2) to block the combined streams from provision to the display device. Thus, the ES control circuitry 558 is configured to compare the maximum required ES value 567 to a display ES value 563, indicating the encryption standard for the display device 122. In some implementations, the display device 122 provides the display ES value 563 to the display controller 105 during a handshake process when the display device 122 is connected to the processing system 100. If the display ES value 563 meets or exceeds the maximum ES value 567, the ES control circuitry 558 encodes the combined stream 570 according, at least, to the encryption standard indicated by the maximum ES value 567 and provides the combined encoded stream to the display device 122. If the display ES value 563 is less than the maximum required ES value 567, the ES control circuitry 558 blocks provision of the combined content stream to the display device 122.

Similarly, if the display ES value 565 meets or exceeds the maximum required ES value 568, the ES control circuitry 559 encodes the combined stream 571 according to, at least, the encryption standard indicated by the maximum ES value 568 and provides the encoded stream to the display device 124. If the display ES value 565 is less than the maximum ES value 568, the ES control circuitry 559 blocks provision of the combined content stream to the display device 124. Thus, the display engine 105 selectively and independently blocks or provides encrypted content to the different display devices 122 and 124 based on the encryption standard of the individual display devices, rather than reducing the quality of the video streams such that their required ES level is less than or equal to the lowest encryption standard of between the display devices. The display engine 105 thus supports security of the content streams while providing a satisfying user experience.

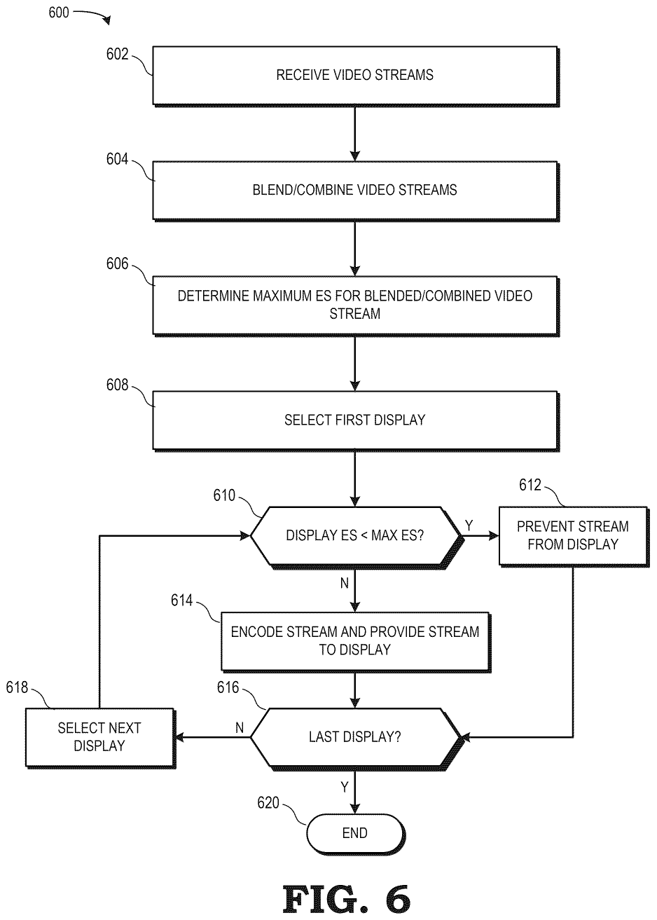

FIG. 6 illustrates a flow diagram of a method 600 of selectively providing and blocking content streams at a display engine in accordance with some implementations. For purposes of description, the method 600 is described with respect to an example implementation at the processing system 100 of FIG. 1. However, it will be appreciated that, in other implementations, the method 600 is implemented at processing systems having a different configuration.

At block 602, the display engine 105 receives one or more video streams from one or more of the processing engines 102-104, 106, and 107. In some implementations, each video stream is generated on behalf of a corresponding DRM pipe, and each DRM pipe is associated with a required encryption standard (ES), such as HDCP 1.x, HDCP 2.x, and the like. Each received video stream has a required encryption standard according to the ES associated with the DRM pipe. In addition, each DRM pipe is assigned a key ID by the RoT processing unit. The key ID indicates a keyspace assigned to the DRM pipe, and also indicates the ES of the DRM pipe. In addition, each of the video streams indicates one or more of the display devices 122 and 124 as targeted display devices, representing a request to display the video stream, or a portion thereof, at each targeted display device.

At block 604, the display engine 105 blends, combines, or both blends and combines video streams that target the same display device. This generates one or more blended/combined streams. At block 606, the display engine 105 determines, for each blended/combined stream, the maximum required ES value among all the video streams used to generate the blended/combined stream. Thus, for example, if a blended/combined stream includes a stream with a required encryption standard of ES 1.0 stream (e.g., an HDCP 1.x stream) and includes a stream with a required encryption standard of ES 2.0 (e.g., an HDCP 2.x stream), the display engine 105 determines a maximum required ES value of 2.0 for the blended/combined stream.

At block 608, the display engine 105 selects the first of the plurality of connected display devices that is targeted by a video stream (either a blended/combined stream or a single video stream). At block 610, the display engine 105 compares the ES for the selected display (that is, the highest ES that the display complies with) to the maximum required ES value for the video stream targeting the selected display. In the case of a single video stream, the maximum ES value is the required ES value for the DRM pipe associated with the stream. For a blended/combined stream, the maximum required ES value is the maximum ES value identified at block 606. If the ES for the display is less than the maximum required ES value, the display does not provide protection for the video stream. Accordingly, the method flow moves to block 612 and the display engine 105 does not provide the video stream to the display device. The method flow moves to block 616, described below.

If, at block 610, the ES of the display device is equal to or greater than the maximum required ES value for the video stream, the method flow moves to block 614 and the display engine 105 provides the video stream to the display device. The method flow moves to block 616 and the display engine 105 determines if all the targeted display devices have been processed. If not, the method flow moves to block 618 and the display engine 105 selects the next display targeted by a video stream. The method returns to block 610. If, at block 616, the last display has been processed, the method flow moves to block 620 and the method ends.

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

1. A method comprising:
receiving, at a display engine, a first video stream designated to be encrypted according to a first encryption standard;
in response to identifying that first security characteristics of a first display device match the first encryption standard, providing the first video stream to the first display device; and
in response to identifying that second security characteristics of a second display device do not match the first encryption standard, preventing provision of the first video stream to the second display device.

2. The method of claim 1, further comprising:
receiving a second video stream designated to be encrypted according to a second encryption standard; and
in response to identifying that the first security characteristics of the first display device match the second encryption standard, providing the second video stream to the first display device.

3. The method of claim 2, further comprising omitting encryption of a third video stream based on the third video stream being designated for one of an integrated display and an embedded display.

4. The method of claim 2, wherein the first encryption standard and the second encryption standard are different versions of a High-bandwidth Digital Content Protection (HDCP) standard.

5. The method of claim 2, further comprising:
for a third video stream identifying whether the first security characteristics of the first display device match a maximum standard value between a third encryption standard and a fourth encryption standard.

6. The method of claim 5, further comprising:
in response to identifying that the first security characteristics of the first display device do not match the maximum standard value, preventing provision of the third video stream to the first display device.

7. The method of claim 5, wherein the maximum standard value is based on a fourth video stream and a fifth video stream being blended into the third video stream for display at the first display device.

8. The method of claim 5, wherein the maximum standard value is based on a fourth video stream and a fifth video stream being combined into the third video stream for display at the first display device.

9. A processor comprising:
a first processing circuit configured to generate a first video stream designated to be encrypted according to a first encryption standard;
a display circuit configured to:
in response to identifying that first security characteristics of a first display device match the first encryption standard, provide the first video stream to the first display device; and
in response to identifying that second security characteristics of a second display device do not match the first encryption standard, prevent provision of the first video stream to the second display device.

10. The processor of claim 9, wherein the display circuit is configured to:
receive a second video stream designated to be encrypted according to a second encryption standard; and
in response to identifying that the first security characteristics of the first display device match the second encryption standard, provide the second video stream to the first display device.

11. The processor of claim 10, further comprising:
a second processing circuit configured to generate the second video stream.

12. The processor of claim 10, wherein the first encryption standard and the second encryption standard are different versions of a specified digital content protection standard.

13. The processor of claim 12, wherein the first encryption standard and the second encryption standard are different versions of a High-bandwidth Digital Content Protection standard.

14. The processor of claim 10, wherein the display circuit is configured to:
identify, for a third video stream whether the first security characteristics of the first display device match a maximum standard value between a third encryption standard and a fourth encryption standard.

15. The processor of claim 14, wherein the display engine is configured to:
in response to identifying that the first security characteristics of the first display device do not match the maximum standard value, prevent provision of the third video stream to the first display device.

16. The processor of claim 15, wherein the maximum standard value is based on a fourth video stream and a fifth video stream being blended into the third video stream for display at the first display device.

17. A processing system comprising:
a first processing circuit configured to generate a first video stream designated to be encrypted according to a first encryption standard;
a first display device and a second display device; and
a display circuit configured to:
in response to identifying that first security characteristics of the first display device match the first encryption standard, provide the first video stream to the first display device; and
in response to identifying that second security characteristics of a second display device do not match the first encryption standard, prevent provision of the first video stream to the second display device.

18. The processing system of claim 17, wherein the display circuit is configured to:
receive a second video stream designated to be encrypted according to a second encryption standard; and
in response to identifying that the first security characteristics of the first display device match the second encryption standard, provide the second video stream to the first display device.

19. The processing system of claim 18, further comprising:
a second processing circuit configured to generate the second video stream.

20. The processing system of claim 18, wherein the first encryption standard and the second encryption standard are different versions of a specified digital content protection standard.
